(19) United States
(12) Patent Application Publication
(10) Pub. No.: US 2017/0293924 A1
(43) Pub. Date: Oct. 12, 2017

(54) SYSTEM AND METHOD FOR THE EXCHANGE OF CONSUMER DATA

(71) Applicant: Frank A. Muzio, Hingham, MA (US)

(72) Inventor: Frank A. Muzio, Hingham, MA (US)

(21) Appl. No.: 15/484,457

(22) Filed: Apr. 11, 2017

Related U.S. Application Data
(60) Provisional application No. 62/320,802, filed on Apr. 11, 2016.

(51) Int. Cl. G06Q 30/02; G06Q 50/00

(52) U.S. Cl. CPC G06Q 30/0204; G06Q 50/01; G06Q 30/0269

(57) ABSTRACT

A data exchange facilitator utilizes a designated webserver to assist in the electronic exchange of consumer data between a plurality of consumers and a plurality of data purchasers. Each consumer continuously uploads data, such as personal information and purchasing preferences, onto a designated consumer profile page hosted by the webserver. Certain content provided by each consumer is restricted for access by data purchasers based on temporal and financial terms, which are initially stipulated by the consumer but remain negotiable between parties. Once the terms for such content are mutually agreed upon by both parties, the webserver provides access to the content and initiates the required payment transaction through a designated financial processing service. To authenticate the veracity of consumer data prior to purchase, the data exchange facilitator engages in a verification process and marks properly authenticated consumer profiles with an appropriate identifier.

### FIELD OF THE INVENTION

The present invention relates generally to the field of consumer marketing and, more particularly, to the acquisition of consumer data to more effectively engage in targeted marketing, staffing, recruiting, ecommerce, advertising, lead generation, as well as customer reviews and ratings.

### BACKGROUND OF THE INVENTION

Targeted marketing is a process in which businesses direct, or target, the marketing of specific products and/or services to a particular group of consumers. As part of an effective targeted marketing strategy, consumer data is commonly acquired and analyzed in order to identify useful patterns and trends amongst the consuming public. As can be appreciated, consumer data often encompasses a variety of different consumer factors, such as geographic, socioeconomic and behavioral factors. All this information is then evaluated to identify the consumer groups that are most likely to purchase a particular product and, in turn, determine the most effective means to market the product to such groups.

Traditionally, relevant consumer data is obtained by targeted marketers from data aggregation and analytic services. The underlying data is generally compiled by such services either through the use of consumer surveys and/or by monitoring electronic historical activity of the consuming public, often without their direct knowledge or permission.

In view thereof, it is to be understood that consumer data has a considerable amount of value to product marketers. However, the individuals that provide such valuable information (i.e. the consuming public) typically derive little, if any, financial benefit from providing such data. In fact, at this time, the consuming public not only receives inadequate compensation for providing valuable consumer data but also is largely helpless in controlling its dissemination. The majority, if not the entirety, of the compensation for access to valuable consumer data is received by corporate entities, such as data aggregation services, marketing agencies, retail businesses and social media.

### SUMMARY OF THE INVENTION

It is an object of the invention to provide a new and improved system and method for facilitating the electronic exchange of consumer data, such as personal information and preferences, between a plurality of consumers and a plurality of data purchasers.

It is another object of the present invention to provide a data exchange system and method as described above that affords each of the plurality of consumers with full control over the dissemination of his/her consumer data to the plurality of data purchasers.

It is yet another object of the present invention to provide a data exchange system and method as described above that affords each of the plurality of consumers with appropriate compensation for access to his/her consumer data.

It is still another object of the present invention to provide a data exchange system and method as described above that enables each of the plurality of consumers to negotiate with the plurality of data purchasers regarding the compensation rate required for access to his/her consumer data.

It is yet still another object of the present invention to provide a data exchange system and method as described above that is simple to use, readily scalable in size, and inexpensive to implement.

Accordingly, as one feature of the present invention, there is provided a system for facilitating the electronic exchange of consumer data, the system comprising (a) a plurality of consumers, each of the plurality of consumers having a compute device, (b) a plurality of data purchasers, each of the plurality of data purchasers having a compute device, and (c) a data exchange facilitator having a server in electronic communication with the compute device for each of the plurality of consumers, the server being in electronic communication with the compute device for each of the plurality of data purchasers, (d) wherein the data exchange facilitator compiles consumer data uploaded from each of the plurality of consumers, the data exchange facilitator maintaining a table that cross-references data uploaded by each of the plurality of consumers with terms for electronic access by each of the plurality of data purchasers.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a simplified block diagram of a system for facilitating the electronic exchange of consumer data, the system being designed according to the teachings of the present invention;

FIG. 2 is a flow chart depicting an overview of a novel method for facilitating the electronic exchange of consumer data using the system shown in FIG. 1; and

FIGS. 3(a)-(m) are a series of sample screen displays which are useful in understanding the method shown in FIG. 2.

### DETAILED DESCRIPTION OF THE INVENTION

### Data Exchange System 11

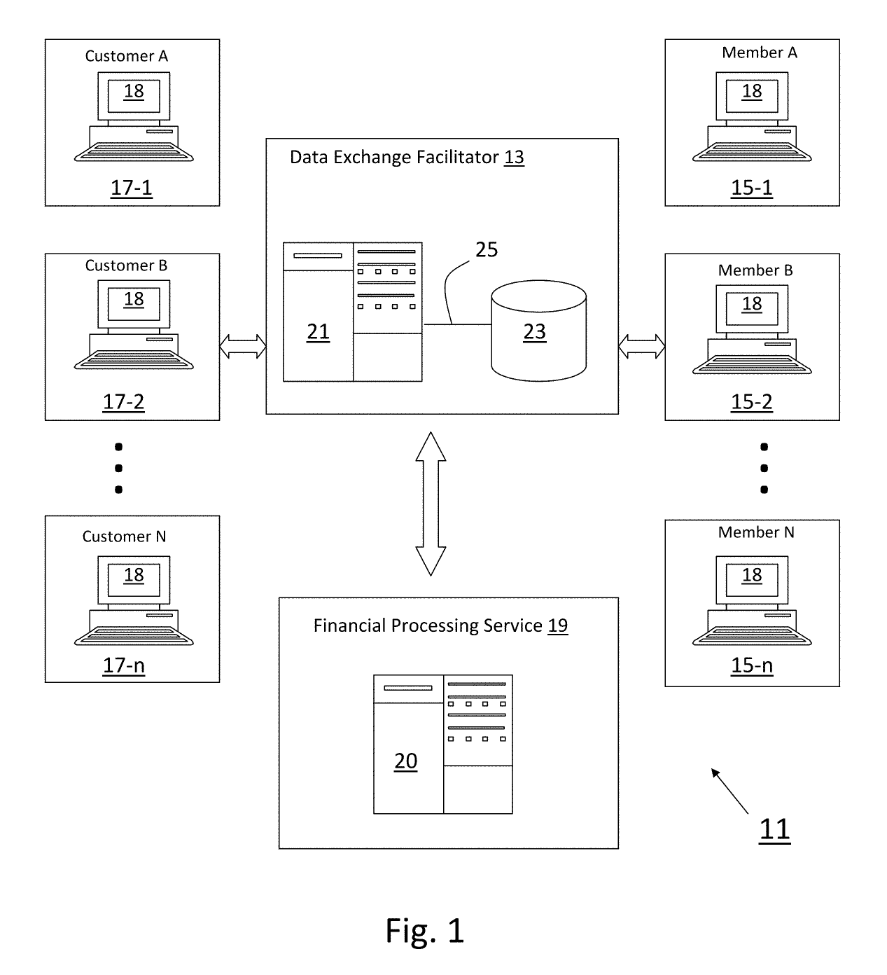

Referring now to FIG. 1, there is a shown a simplified block diagram of a system that facilitates the electronic exchange of consumer data, the system being designed according to the teachings of the present invention and identified generally by reference numeral 11. As will be described further below, system 11 provides a consumer with full control and appropriate compensation for access to his/her personal information, which is a principal object the present invention.

As can be seen, system 11 comprises a data exchange facilitator 13 which serves as the central hub between a plurality of individual consumers, or members, 15-1 thru 15-n, and a plurality of individual data purchasers, or customers, 17-1 thru 17-n. Each consumer 15 (i.e., a person of the general consuming public) and each data purchaser 17 (i.e., a business entity typically engaged in compiling and evaluating consumer data) preferably interacts within system 11 using an appropriate compute device 18, such as a personal computer or web-enabled mobile device.

Data exchange facilitator 13 is also electronically linked with at least one financial processing service 19 that is able to conduct an electronic financial transaction on behalf of each participant in system 11. For simplicity purposes only, financial processing service 19 is shown comprising a central controller 20, such as a web server.

As defined herein, financial processing service 19 represents any service capable of conducting an electronic financial transaction amongst participants in system 11. For instance, service 19 may be in the form of the PayPal® digital payment service. Accordingly, by enrolling each participant with financial transaction service 19, appropriate funds can be delivered to, or withdrawn from, each participant by facilitator 13 through a corresponding financial account established with service 19.

Facilitator 13 preferably comprises a central controller 21 and a data storage device 23 in electronic communication with one another via network path 25. As can be appreciated, central controller 21 serves as the functional hub of system 11 and is electronically linked with members 15, customers 17, and financial processing service 19 by any communication means suitable for the electronic transfer of data, such as the internet. For instance, controller 21 is represented herein as a web server that is responsible for regulating the exchange of data between participants of system 11 through one or more designated web pages.

As will be explained further below, data storage device 23 is responsible for, among other things, compiling and cross-referencing consumer data (e.g., purchasing preferences) with a consumer-specified cost for the right to access to such data. In this manner, data exchange facilitator 13 streamlines the manner in which consumer data is purchased by marketers by eliminating the involvement of traditional intermediaries that receive financial compensation for access to the data in lieu of the actual consumer.

### Method for the Exchange of Consumer Data between Members and Customers

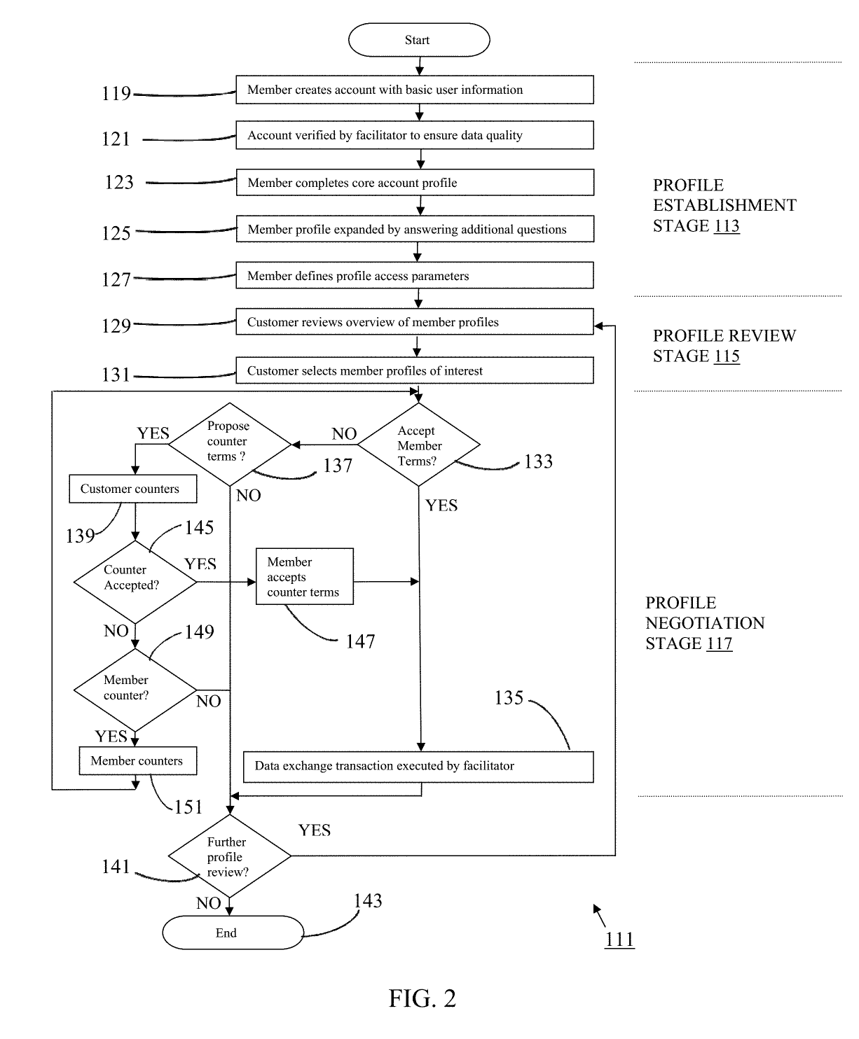

As referenced above, system 11 facilitates the electronic exchange of validated, personal consumer data from a member 15 to an interested customer 17 under temporal and financial terms that are agreed upon by both parties. In the description that follows, a preferred method for the exchange of consumer data between members 15 and customers 17 is shown in FIG. 2, the method being identified generally by reference numeral 111.

As will be explained further in detail below, method 111 relies generally upon a three stage process for facilitating the exchange of consumer data between a member 15 and a customer 17. Specifically, method 111 includes (i) a profile establishment process 113 wherein each member 15 establishes and continuously updates a user profile that includes validated, personal consumer information as well as the terms and conditions for access thereto, (ii) a profile examination stage 115 wherein a customer 17 reviews a limited content overview of certain member profiles and selects profiles of interest, and (iii) a profile negotiation stage 117 wherein customer 17 negotiates with selected members 15 for full profile access and, if the terms mutually agreed upon, exchange full profile access for payment in compliance with the agreed-upon terms.

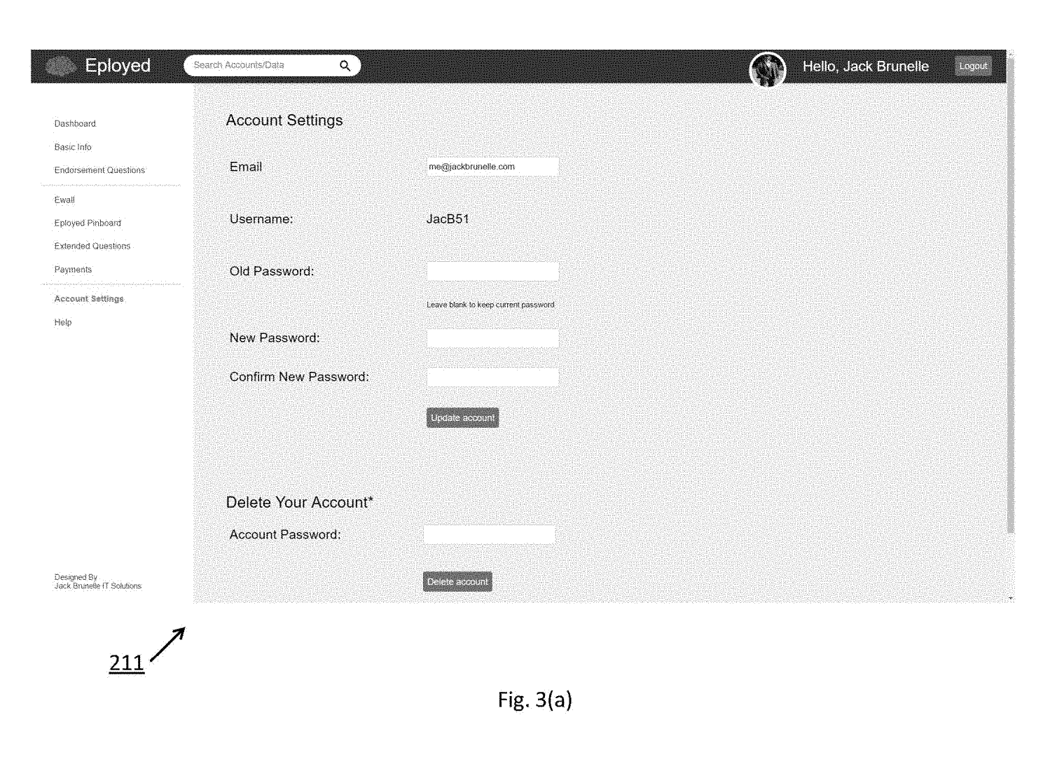

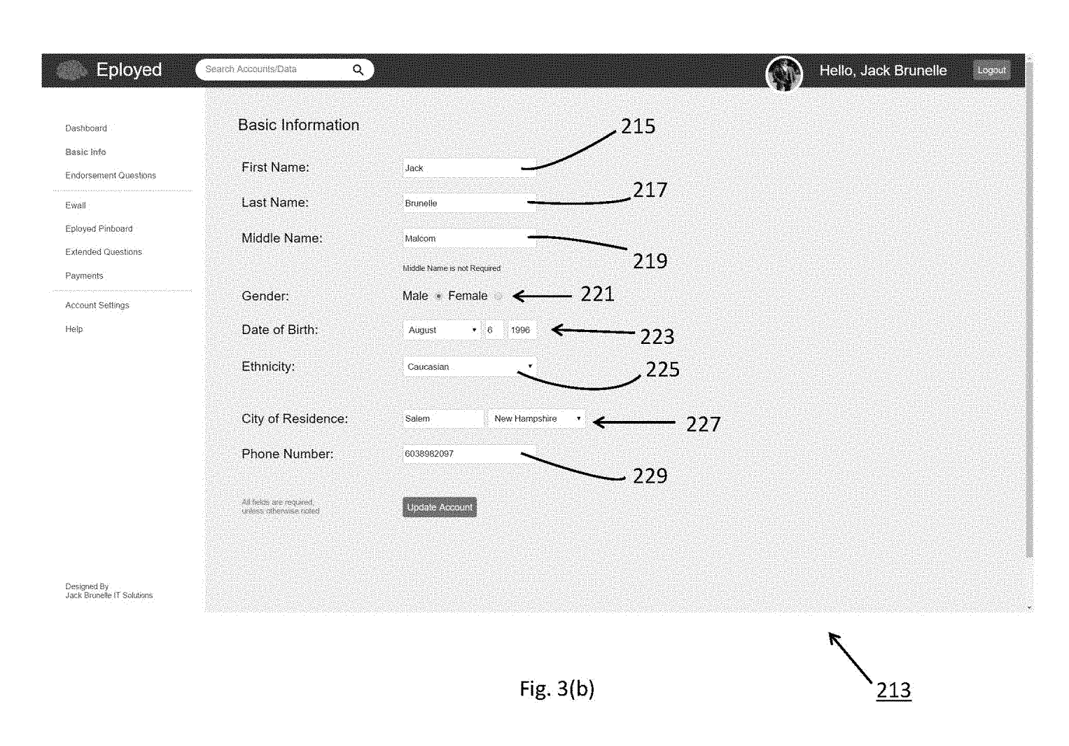

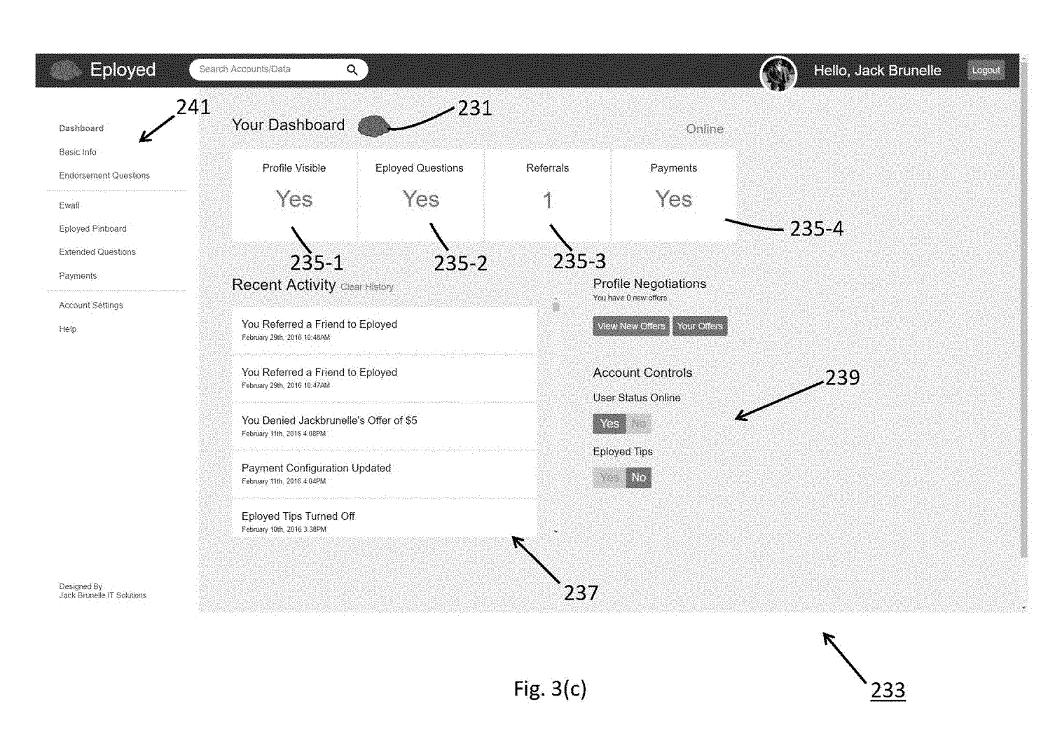

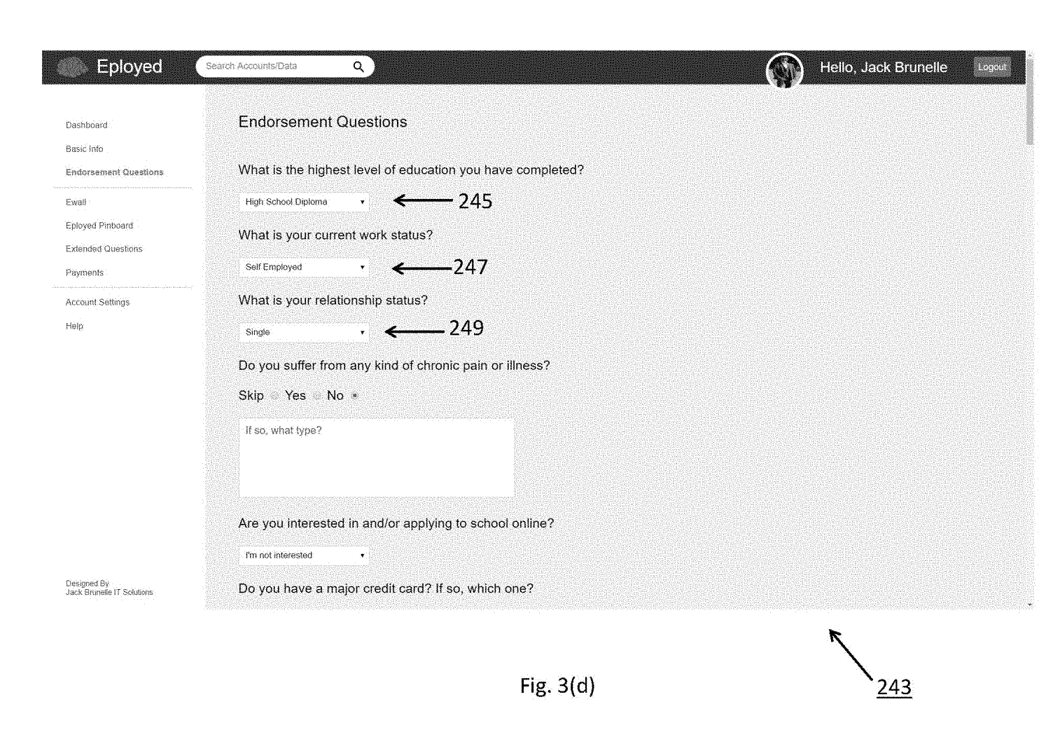

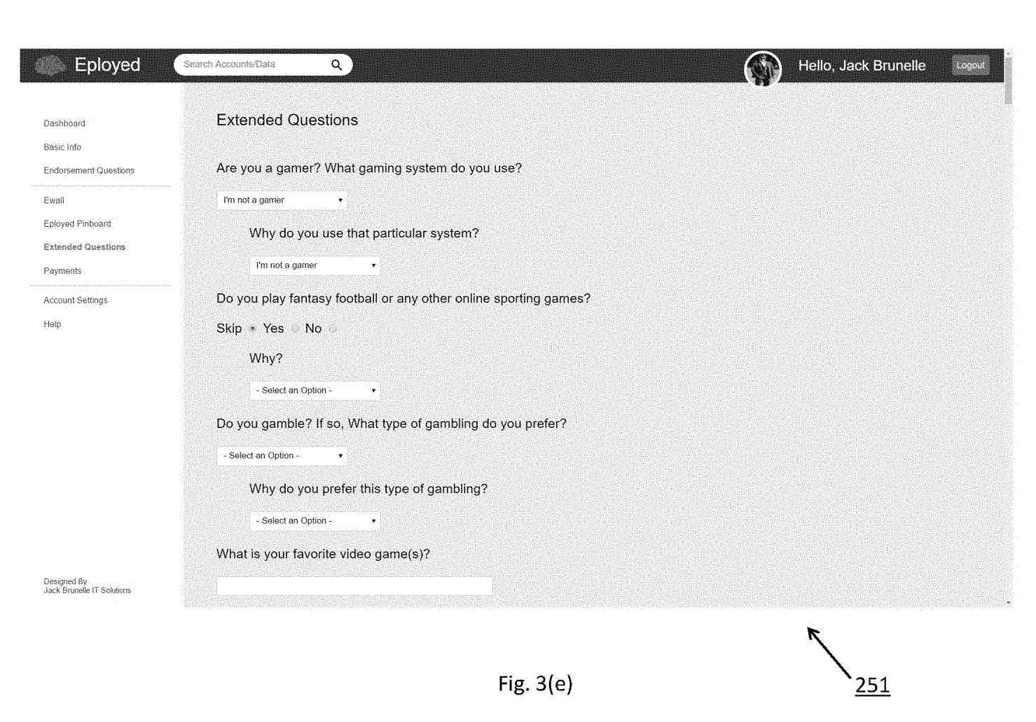

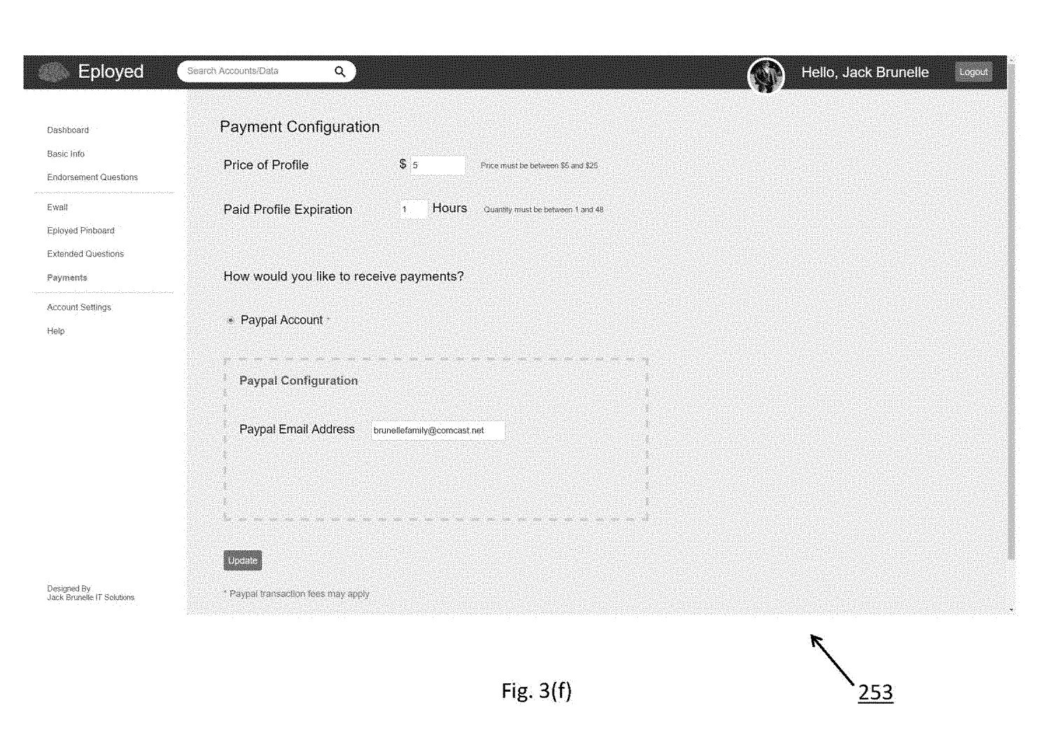

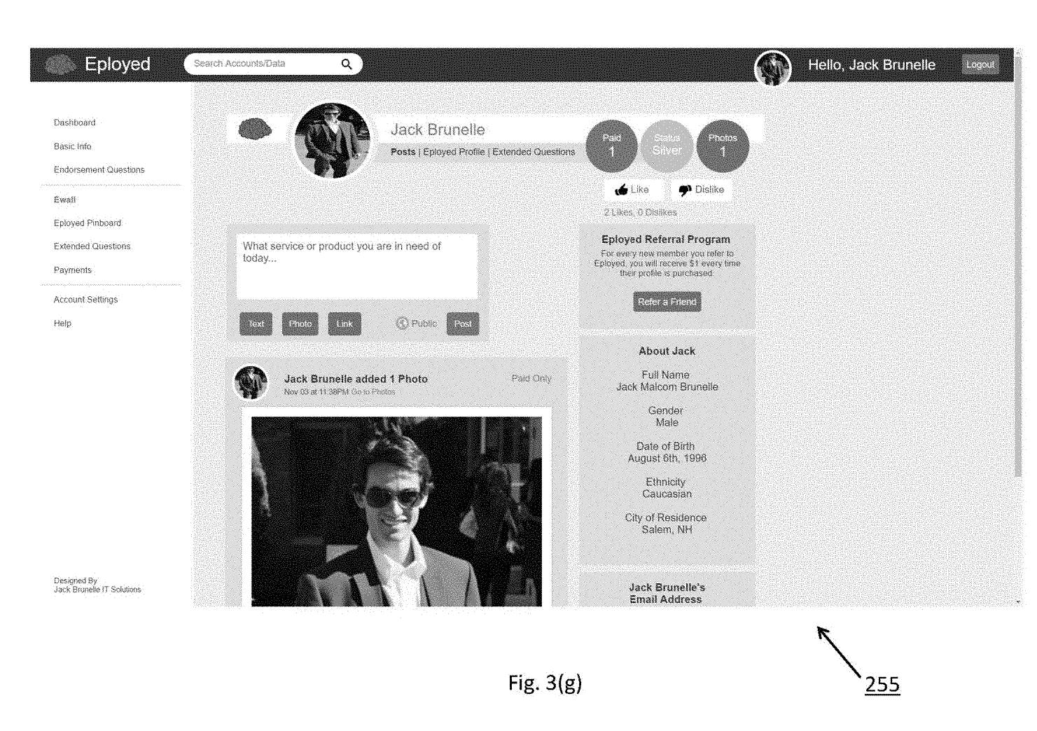

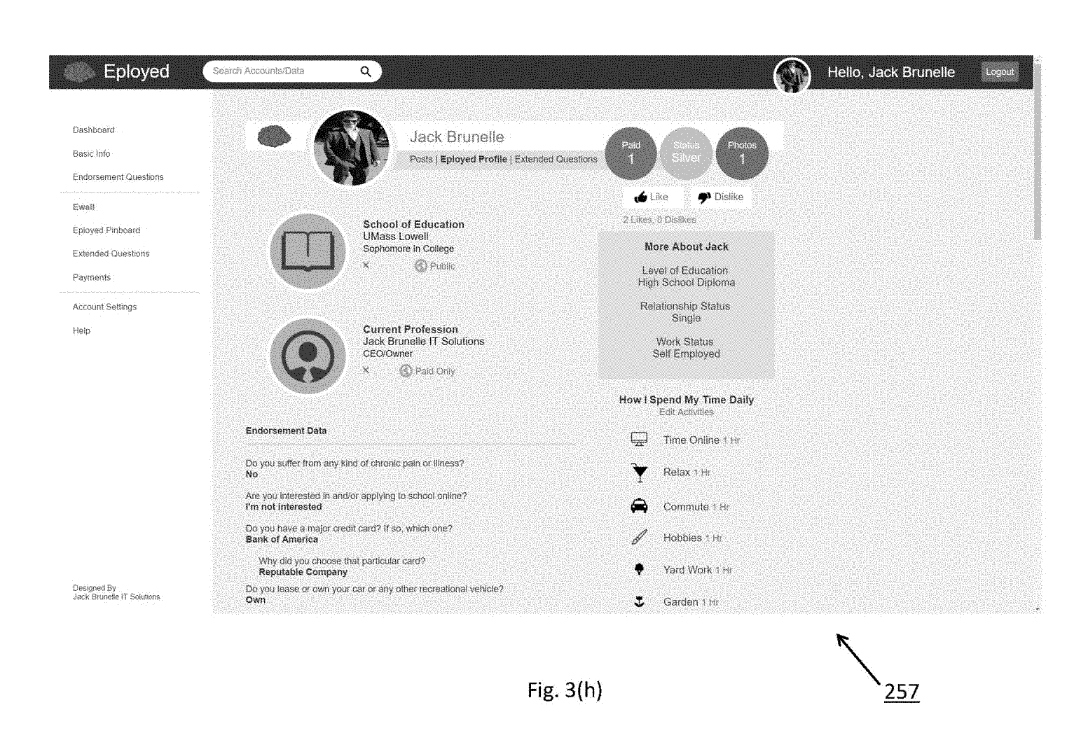

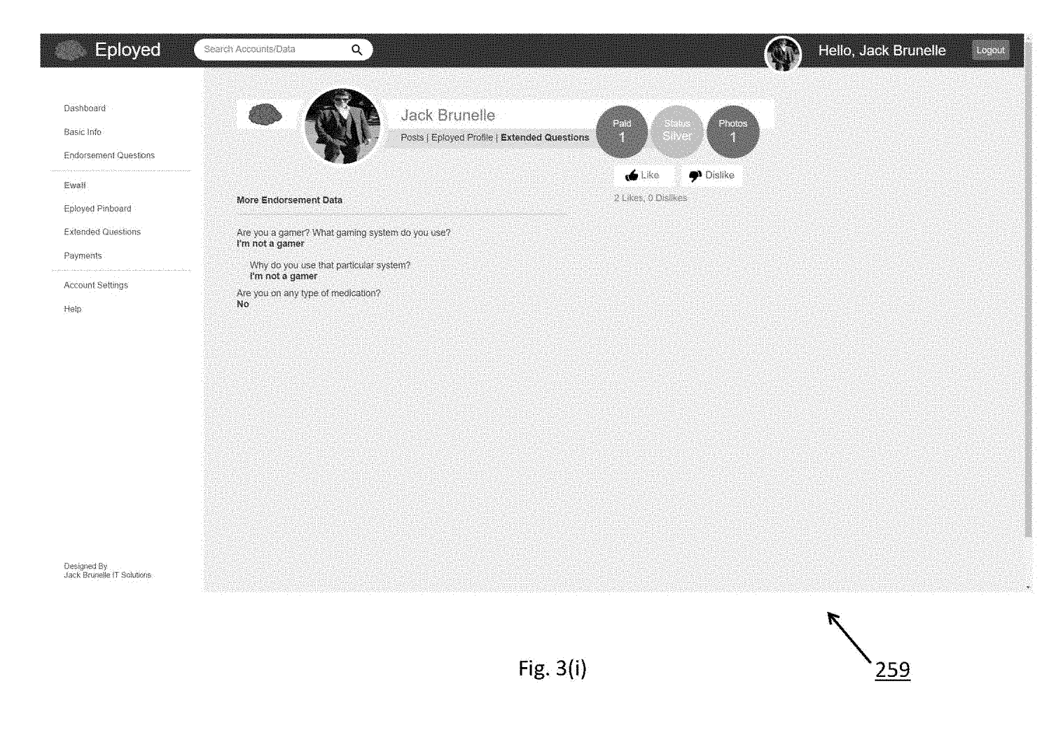

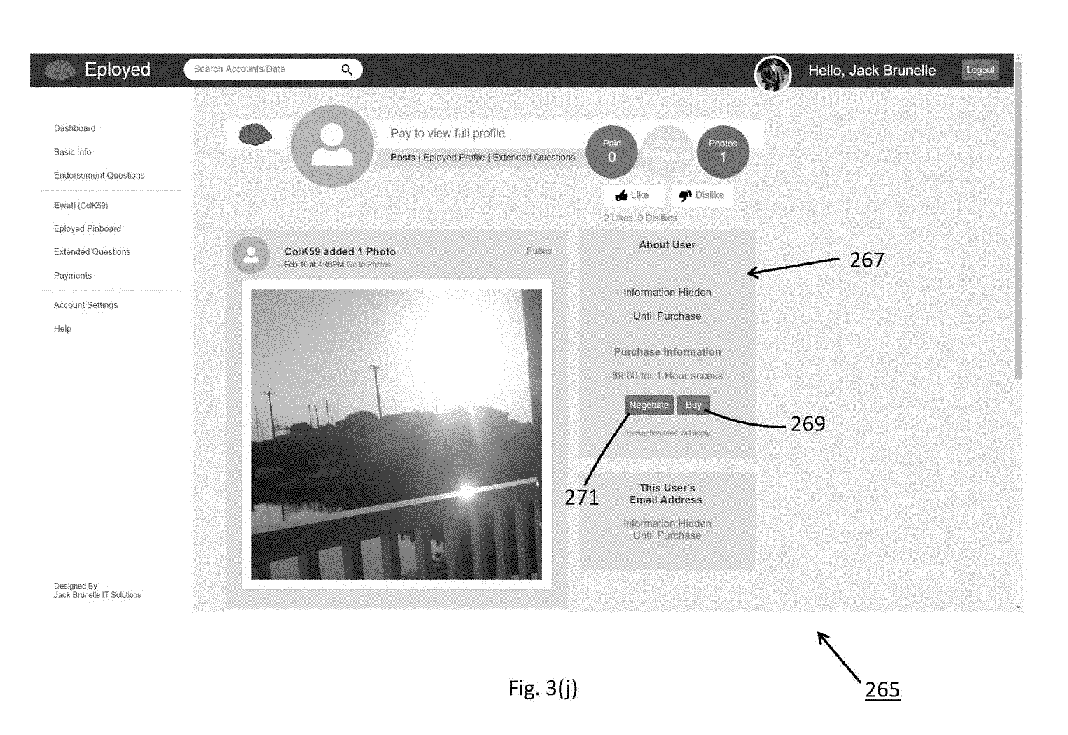

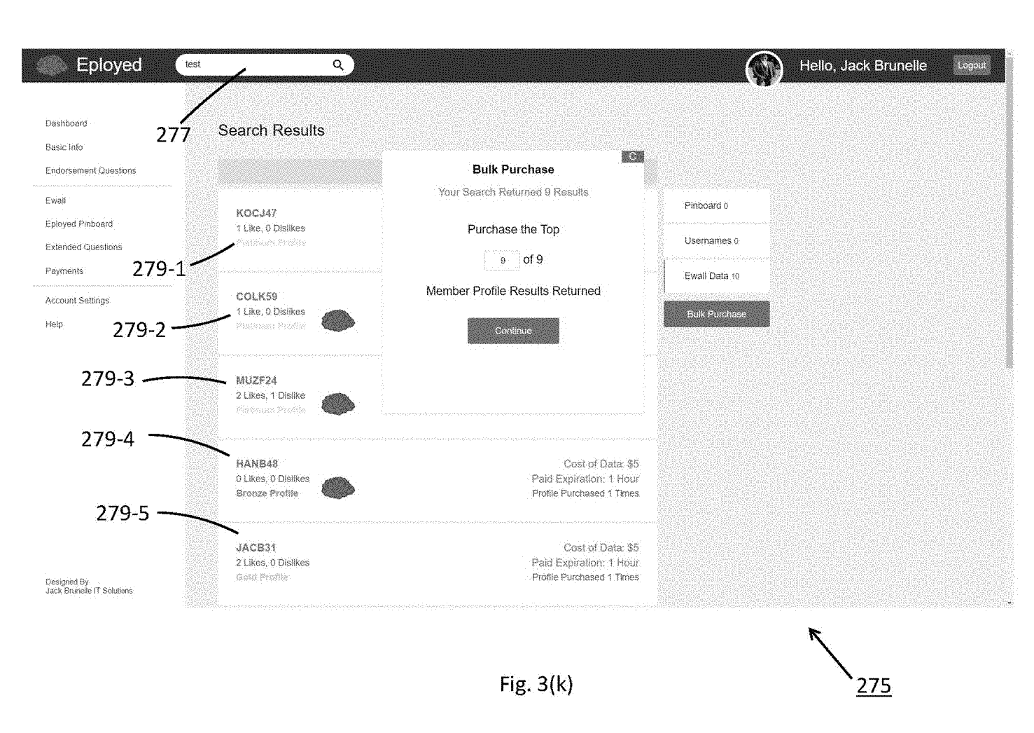

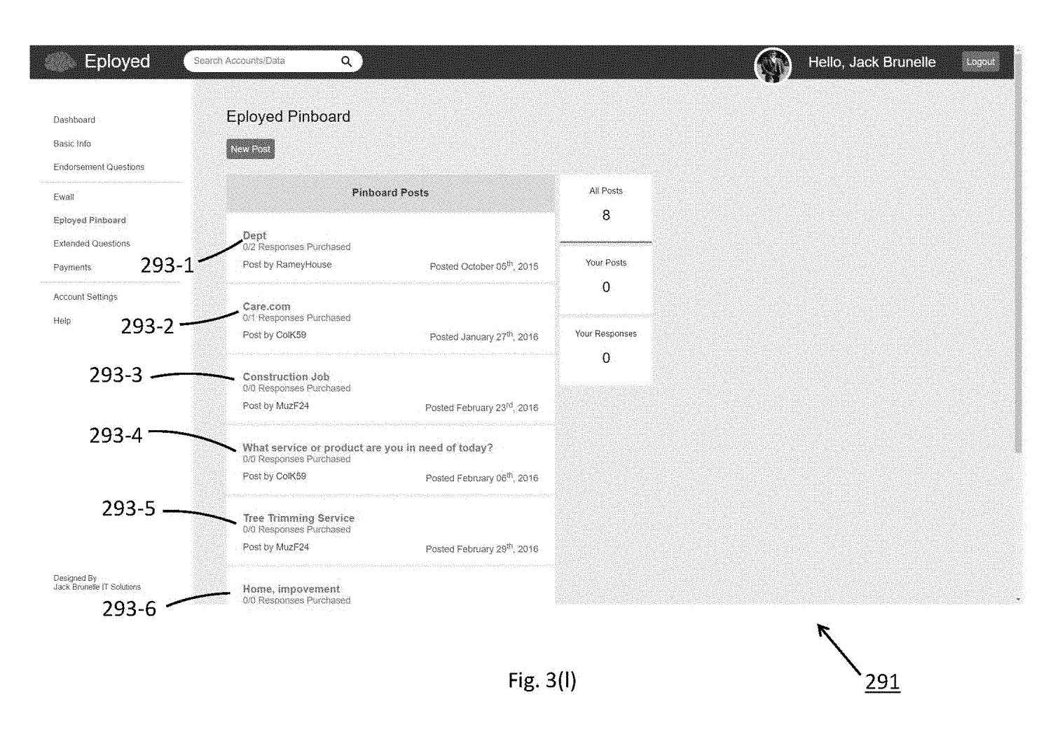

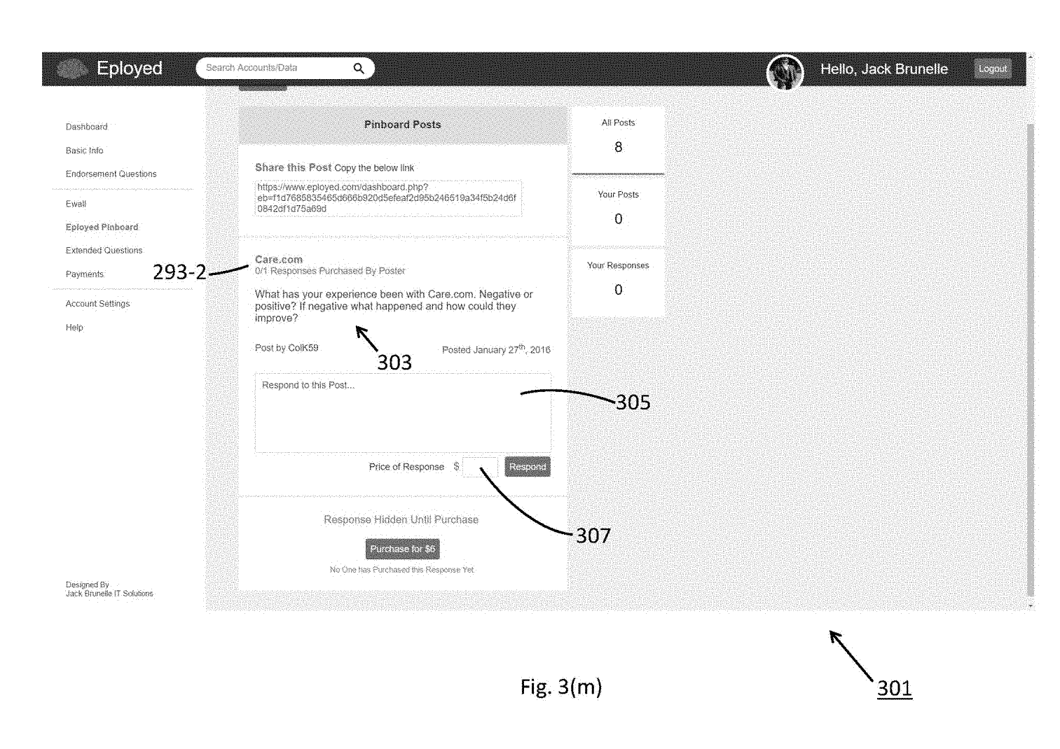

As seen in FIG. 2, the first step of data exchange process 111 requires each member 15 to create an electronic profile, or account, through a designated web portal, as represented by reference numeral 119. As part of the initial setup, a user name and password is preferably established for member. In FIG. 3(a), there is shown a sample screen display 211 which shows how member 15 can modify the password associated with the account, if desired.

As part of account creation step 119, member 15 is required to enter some basic user information. In FIG. 3(b), there is shown a sample screen display 213 which indicates certain basic user information required from member 15 including, but not limited to, first name 215, last name 217, middle name 219, gender 221, date of birth 223, ethnicity 225, place of residence 227, and telephone number 229. At any time, the basic user information can be modified and updated by member 15, as required.

Referring back to FIG. 2, once the member account is created, facilitator 13 engages in a verification process to authenticate the identity of member 15, as represented by step 121. Verification step 121 is preferably achieved through direct personal interaction with member 15 by a representative, or agent, of facilitator 13. To verify authenticity, the agent preferably requires member 15 to provide one or more of the following: a license, passport or bank information. In this manner, facilitator 13 is able to ensure that member 15 is an actual person of a legal age and holds only a single account within system 11 (i.e. not a virtual identity created for unscrupulous reasons).

Accordingly, verification step 121 functions as a quality control factor to ensure that the information provided by each member 15 is validated as authentic, true and accurate. Upon verification, the user profile is provided with an authenticated marker, or label, which is represented in later figures as logo 231.

In step 123, member 15 completes the core user profile. Completion of the core user profile is accomplished by answering a set of endorsement questions relating to the user, examples of which are provided below. As will be explained further below, certain personal information entered in steps 119 and 123 remains private and is unavailable for examination by customers 17 and/or other members 15 until payment for access is received.

Step 123 is achieved primarily by logging into system 11, which directs member 15 to his/her dashboard, or homepage. For ease in understanding, a sample dashboard 233 is shown in FIG. 3(c). As can be seen, in addition to verification logo 231, dashboard page 233 displays the primary state of the account through status windows 235-1 thru 235-4, scrollable activity window 237 and controls 239. Additionally, dashboard 233 includes a vertical column of links 241 which enable the user to access separate functional pages of the account.

As noted above, each profile is provided with a series of basic endorsement questions that completes the core user data for the profile. For instance, as seen in sample screen display 243 shown in FIG. 3(d), certain socioeconomic and general profile questions are requested of the user (through corresponding dropdown windows), the questions including, among other things, the education status 245, work status 247, and relationship status 249 of the user.

Once all of the standard endorsement questions are answered, the user profile status is reflected as such. Specifically, endorsement questions status window 235-2 in FIG. 3(c) is displayed with the positive indicator, “yes.”

In step 125 of FIG. 2, member 15 preferably expands his/her profile by incorporating more detailed personal information (e.g. consumer preferences) with the user profile. It is to be understood that the inclusion of this additional information is at the sole discretion of member 15.

As an example, FIG. 3(e) is a sample screen display 251 which includes a series of extended questions. Using the series of extended questions, member 15 is able to incorporate very specific personal information and consumer preferences into his/her profile. For instance, in the example shown, member 15 has the option to answer one or more extended questions that relate to, inter alia, video games and gambling. However, it is to be understood that the present invention is not limited to any particular set of extended questions, but rather could include any set of questions that are useful to target marketers in determining consumer preferences.

Additionally, the user has the capability to further enhance his/her profile by answering additional information through a community pinboard of specific questions, the details of the pinboard to be explained further below.

As referenced above, answering endorsement and/or pinboard questions is optional and at the sole discretion of member 15. However, it is to be understood that the more data added to the member profile in step 125 increases its overall value to potential customers 17 since effective targeted marketing commonly relies upon as much consumer data as possible. In view thereof, a sliding profile scale is preferably associated with each account to reflect the amount and quality of data provided by member 15. More particularly, as the amount and quality of information is input by member in step 125, the status of the profile sequentially advances from bronze status, to silver status, to gold status, and finally to platinum status. As will become apparent below, the particular status of a member profile is useful in determining the commensurate value for access to its content.

In addition to linking personal information with his/her member profile, member 15 is able to establish the parameters for access to the restricted content, this access parameter step being represented by reference numeral 127 in FIG. 2. More specifically, member 15 is able to define, among other things, the price and length of time that one may access the entirety of the member profile, including restricted content. Additionally, member 15 preferably provides his/her unique banking information (e.g. an account number) with financial processing service 19 so that payments can be electronically wired to the member account in exchange for access to the restricted content. For ease in understanding, a sample payment configuration screen display is shown in FIG. 3(f) and identified generally by reference numeral 253.

The access price defined by member 15 in step 127 preferably reflects the quantity and quality of information provided in his/her profile. In other words, a profile containing quality content should be able to carry a relatively expensive access rate (e.g. $10). A rate above a maximum threshold (e.g. $25) may require direct contact with facilitator 13 to determine its appropriateness.

As a principal feature of the present invention, full control of consumer data is therefore retained by the individual who provides the information. Additionally, compensation for such information is paid directly to the party who is providing the information and not to an intermediary party. Optionally, a small transactional fee (e.g., $1) may be automatically withdrawn by facilitator 13 in exchange for supporting and managing the compensated data exchange process.

All member profiles 17 are compiled and stored in database 23, with profiles 17 available for continuous updates by members 15, as desired. Access to such profiles by customers 17 (as well as other members 15) is readily available through web server 21.

Having completed the profile establishment stage 113, method 111 proceeds to the profile review stage 115. Specifically, in step 129, customer 17 (or potentially another member 15) reviews member profiles for possible purchase of the consumer data contained therein. As can be appreciated, each data purchaser 17 is similarly required to create an account with facilitator 13 in order to gain access to member profiles. Preferably, each customer account is similar to a member account in that certain basic information (e.g. banking information) needs to be provided via internet server 21. However, unlike a member profile, each customer account may include a plurality of sub-accounts (e.g. if a single company has multiple employee users).

Preferably, each member profile is represented to other viewers (e.g., customers 17) through a series of webpages that together form an electronic profile wall, or Ewall. As will be explained below, each Ewall provides a user-intuitive and stylistic means for viewing both selected free content and restricted content associated with the profile.

Specifically, as seen in as seen in sample screen display 255 shown in FIG. 3(g), the user Ewall includes a profile homepage, or post page, that includes a user-intuitive overview of certain core information provided by the user, such as name, gender, location, date of birth, contact information, etc. Additionally, the profile homepage indicates the current user profile status (e.g. silver) and the number of times member 15 has received compensation for full access to the member profile (e.g. paid 1).

It should also be noted that profile homepage 255 functions not only as a user-intuitive page for reviewing certain profile information but also as a social media forum where member 15 can post photographs or other interesting information that he/she wishes to share with others in system 11.

As seen in sample screen display 257 shown in FIG. 3(h), each member profile additionally includes a profile page which includes much of the user information provided in step 123 (e.g. education, work status, and consumer preferences). Lastly, as seen in sample screen display 259 shown in FIG. 3(i), each member profile additionally includes an extended question page which includes any extended questions (i.e. the consumer preferences) or pinboard questions that were answered by member in step 125.

It should be noted that, as part of profile review step 129, a party interested in compiling consumer data (e.g. customer 17-1) is only able to view limited profile content (e.g. questions answered in step 123) without payment. For instance, a sample screen display 265 is shown in FIG. 3(j) which displays some of the limited data that one can view on another member Ewall without payment (e.g. profile status, posts and selected basic member information). In addition to the limited data, screen display 265 includes a purchase window 267 which indicates the profile access parameters established by member 15 in step 127 (e.g. $9.00 for 1 hour of profile access) as well as a “buy” button 269 and a “negotiate” button 271, the function of each to be explained further below.

To assist in profile review step 129, the user-interface provided by server 21 includes a search tool. Specifically, as seen most clearly in sample screen display 275 shown in FIG. 3(k), a search window 277 is provided at the top of each webpage. Using an appropriate filtering term (e.g. test), a group of profiles 279-1 thru 279-5 with similar characteristics of potential interest to the data purchasing party (e.g. members 15 within a certain geographic region) is extracted from database 23 and provided in list form for examination.

As can be seen, the search list includes only a limited amount of information regarding the profiles 239 that meet the search parameters. Namely, a brief synopsis of each user includes the following information—user account name, profile status, recommendation status, verification status, and access parameters.

Thereafter, in step 131, data purchaser 17 selects the one or more profiles of interest and, in turn, evaluates whether to negotiate payment for access to the restricted content associated with each selected member profile. It should be noted that the consumer profiles can be selected individually or as part of a bulk purchase.

Once at least one profile of interest has been selected by customer 17, process 111 advances to profile negotiation stage 117. Specifically, as seen in step 133, the customer 17 determines whether the user-defined access terms associated with each desired profile are acceptable. If the terms are acceptable, customer 17 purchases access to the profile (e.g. by clicking on “buy” button 269 provided on the profile Ewall).

In response, server 21 electronically transacts the data exchange, as represented by step 135 in FIG. 2. Namely, facilitator 13 provides access to the restricted content to customer 17. In exchange, facilitator 13 instructs financial processing service 19 to withdraw the agreed-upon access fee from the financial account associated with customer 17 and credit that fee to the financial account associated with member 15, less any processing fees retained by facilitator 19.

Once profile access is available, customer 17 can review the entire profile in detail (e.g. as part of targeted marketing research). If additional information about member 15 is desired by customer 17 (e.g. a consumer question not listed on the member profile), customer 17 can contact member 15 directly using previously restricted user contact information, such as an email or telephone number.

By contrast, if the original terms are not deemed acceptable, customer 17 has the option to provide a counteroffer to member 15, as represented in step 137. If a counteroffer of access terms is desired, customer 17 proposes the counteroffer terms in step 139 (e.g. by clicking on “negotiate” button 271 provided on profile Ewall and inputting the terms in appropriate windows). If a counteroffer is not desired, customer 17 determines whether further review of profiles is desired in step 141. If further review is desired, method 111 returns to review step 129. Otherwise, method 111 terminates with end step 143.

The counteroffer proposed by customer 17 is then displayed on the member dashboard when consumer 15 logs into system 11. In response, member 15 determines whether to accept the counteroffer in step 145. If the terms are acceptable, member 15 accepts the terms in step 147 (e.g. by clicking on an “accept” button through the user interface) and, in turn, method 111 proceeds to transaction step 135.

If the terms are not acceptable, member 15 has the option to present new terms for profile access in step 149. If member 15 does not wish to present a modified offer, method 111 advances to step 141. However, if a modified offer is desired, member 15 inputs the new access parameters through an appropriate user-interface in step 151. The status of the new offer is then displayed to customer 17 (e.g. through the customer dashboard). Method 111 thus returns to step 133 and customer 17 decides whether to accept the member terms, as modified. In this manner, additional negotiation between member 15 and customer 17 can occur, as needed.

As noted briefly above, system 11 is designed to support a community pinboard where members 15 and customers 17 can ask and answer specific questions at negotiated prices. In this manner, the pinboard can be used as a forum for posting various types of needs or wants within the system community. As such, the pinboard offers a wide range of potential applications including, but not limited to, use as an advertising, recruiting, and/or referral tool.

For instance, as seen in sample screen display 291 shown in FIG. 3(1), the pinboard includes a plurality of posts 293-1 thru 293-6 that were created by either members 15 or customers 17 within the community. By clicking on an individual post (e.g. post 293-2) the user is directed to a page which includes the post details, an example of which is seen in sample screen display 301 shown in FIG. 3(m).

As can be seen, pinboard post 239-2 in FIG. 3(m) includes a consumer question 303 and a response window 305 where the user can respond to the question posed. If desired, the answering party can require payment for access to his/her response via price window 307. The party that posted the question, in turn, is able to negotiate with the answering party for access to the response, if desired. If the price terms are successfully negotiated between the two parties, the purchasing party receives the information and the data is permanently posted on the Ewall for the providing party, thereby enhancing the user profile.

In addition to the other features set forth above, system 11 is additionally designed to electronically support the referral of new participants (e.g. by submitting the email address of a potential new member). More specifically, system 11 is designed to provide the referring party with a referral fee (e.g. $1) for every new member 15 that is ultimately verified by facilitator 13. Additionally, the referring party may receive a bonus fee (e.g. $1) every time that the profile of a referred member is accessed at a minimum threshold cost.

The embodiment shown above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A system for facilitating the electronic exchange of consumer data, the system comprising:
(a) a plurality of consumers, each of the plurality of consumers having a compute device;
(b) a plurality of data purchasers, each of the plurality of data purchasers having a compute device; and
(c) a data exchange facilitator having a server in electronic communication with the compute device for each of the plurality of consumers, the server being in electronic communication with the compute device for each of the plurality of data purchasers;
(d) wherein the data exchange facilitator compiles consumer data uploaded from each of the plurality of consumers, the data exchange facilitator maintaining a table that cross-references data uploaded by each of the plurality of consumers with terms for electronic access by each of the plurality of data purchasers.

2. The system of claim 1 wherein wherein consumer data uploaded from each of the plurality of consumers includes information from the group consisting of personal information and purchasing preferences.

3. The system of claim 1 wherein consumer data uploaded from each of the plurality of consumers includes restricted content and unrestricted content.

4. The system of claim 3 wherein a price for access to restricted content uploaded by a first of the plurality of consumers is stipulated by the first of the plurality of consumers.

5. The system of claim 4 wherein the price for access to restricted content uploaded by the first of the plurality of consumers is adapted to be electronically negotiated between the first of the plurality of consumers and a first of the plurality of data purchasers via the server.

6. The system of claim 5 further comprising a financial processing service having a central controller in electronic communication with the server for the data exchange facilitator, the server for the data exchange facilitator instructing the central controller for the financial processing service to execute a financial transaction between one of the plurality of consumers and one of the plurality of data purchasers once a price for access to restricted content is reached.

7. The system of claim 5 wherein the consumer data uploaded by each of the plurality of consumers is displayed on a unique consumer profile page.

8. The system of claim 7 wherein the unrestricted content uploaded by the first of the plurality of consumers is readily available for examination by any of the plurality of data purchasers.

9. The system of claim 8 wherein the restricted content uploaded by the first of the plurality of consumers is only available for examination by the plurality of data purchasers upon acceptance of the terms for electronic access stipulated by the first of the plurality of consumers.

10. The system of claim 7 wherein the electronic profile page for the first of the plurality of consumers is verified for authenticity by the data exchange facilitator.

11. The system of claim 10 wherein the electronic profile page for the first of the plurality of consumers is verified for authenticity using identification information from the group consisting of an identification card, social security number and bank information.

12. The system of claim 10 wherein the electronic profile page for the first of the plurality of consumers is identified with an authentication marking upon verification by the data exchange facilitator.

13. The system of claim 7 wherein the data exchange facilitator assigns a status level to the electronic profile page for the first of the plurality of consumers, the status level being based on the consumer data uploaded by the first of the plurality of consumers.

14. The system of claim 13 wherein the status level falls along a sliding scale that considers the quality and quantity of data uploaded by the first of the plurality of consumers.
